(19) United States
(12) Patent Application Publication
(10) Pub. No.: US 2010/0088749 A1
(43) Pub. Date: Apr. 8, 2010

(54) SYSTEM AND METHOD FOR PERSONAL AUTHENTICATION USING ANONYMOUS DEVICES

(76) Inventor: Philip John Steeples, Derbyshire (GB)

Correspondence Address: MICHAEL BEST & FRIEDRICH LLP, 100 E WISCONSIN AVENUE, Suite 3300, MILWAUKEE, WI, 53202, US

(21) Appl. No.: 12/436,500

(22) Filed: May 6, 2009

(30) Foreign Application Priority Data
May 6, 2008 (IN) 1111/CHE/2008

(51) Int. Cl. H04L 9/32; H04W 12/06

(52) U.S. Cl. 726/4; 455/411; 726/7

(57) ABSTRACT

A system and method for providing personal authentication is provided. The method comprises the steps of prompting a user of an electronic communication device to provide transaction or session input; establishing a session if the transaction or session input is valid; requesting electronic communication device to establish communication with one or more identity modules and one or more anonymous devices in the vicinity, if the electronic communication device is authorized; interrogating one or more identity modules and one or more anonymous device via electronic communication device and authentication server, after the communication is established between the electronic communication device, one or more identity modules and one or more anonymous devices; and activating the electronic communication device if the one or more identity modules and one or more anonymous devices are authenticated by the authentication server.

### FIELD OF INVENTION

The present invention relates to security of electronic devices and more specifically to provide personal authentication to user's electronic communication devices and services via anonymous devices.

### BACKGROUND OF THE INVENTION

Technological advancement has made electronic communication devices inexpensive and accordingly ubiquitous. Electronic communication devices such as mobile phones, personal digital assistants, and other mobile wireless devices are small, transportable, and therefore vulnerable to theft. In situations where mobile phone or other hardware is stolen, there is always a probability that a user may be charged for services which are being misused by an unauthorized person and the problem is further aggravated when the mobile phone or its content are used for illegal activities.

Numerous security techniques such as providing personal identification number (PIN) to lock and unlock the device, providing and requesting tokens from remote server, handshakes etc. have been used in the art to prevent misuse of electronic communication devices and services. However, most of these processes and architecture lend themselves vulnerable to man in the middle attacks and can be easily deciphered to make these devices and services reusable.

Consequently, there is a need for an efficient system and method for identifying true user of electronic communication device discreetly without requiring information about the identity of the person. In addition, there is a need for providing means to disable or restrict functional aspects of electronic communication device or service in the event of its theft or loss. Further, there is a need for a system and method to provide personal authentication to user's electronic communication device via various anonymous devices.

### SUMMARY OF THE INVENTION

A method for providing personal authentication is provided. The method comprises the steps of initiating a session or transaction by providing an input to an electronic communication device; requesting the electronic communication device to establish communication with one or more identity modules and one or more anonymous devices in the vicinity, if the electronic communication device is authorized; interrogating one or more identity modules and one or more anonymous device via electronic communication device and authentication server, after the communication is established between the electronic communication device, one or more identity modules and one or more anonymous devices; and activating the electronic communication device if the one or more identity modules and one or more anonymous devices are authenticated by the authentication server. The method further comprises the step of locking the electronic communication device if the identity module or anonymous device is not authenticated by the authentication server and deactivating the electronic communication device and placing it in a temporary dormant state when it fails to receive a response either from identity module or anonymous device.

In an exemplary embodiment, the transaction or session input may comprise a credit card number, password, PIN, a string of characters, or an anonymous biometric signal. In another exemplary embodiment, the step of authentication of electronic communication device comprises comparing associated unique identifiers thereof against ones stored in an authentication database. In yet another exemplary embodiment, the step of authentication of identity modules comprises comparing associated unique identifiers thereof against ones stored in an authentication database. In yet another exemplary embodiment, the step of authentication of anonymous devices comprises comparing associated unique identifiers thereof against ones stored in an authentication database.

In another exemplary embodiment, method for providing personal authentication comprises the steps of prompting a user of an electronic communication device to provide transaction or session input; establishing a session if the transaction or session input is valid; repeating abovementioned steps if the transaction or session input is not valid; determining if the electronic communication device is authorized by authentication server, if the transaction or session input is valid and a session is established; repeating the abovementioned steps if the electronic communication device is not authorized; requesting electronic communication device to establish communication with one or more identity modules and one or more anonymous devices in the vicinity, if the electronic communication device is authorized; interrogating one or more identity modules and one or more anonymous device via electronic communication device and authentication server, after the communication is established between the electronic communication device, one or more identity modules and one or more anonymous devices; and activating the electronic communication device if the one or more identity modules and one or more anonymous devices are authenticated by the authentication server.

A system for providing personal authentication is provided. The system comprises an electronic communication device for transmitting and receiving data, at least one identity module comprising an integrated transceiver with unique identifier in the vicinity of electronic communication device, at least one anonymous device having unique identifier in the vicinity of electronic communication device, an authentication server providing authorization services to electronic communication device by comparing unique identifiers of electronic communication device, identity modules, and anonymous devices with the ones stored at authentication database. The system further comprises a secondary authentication server for providing critical information and supplementing first authentication server and a secondary authentication database for storing critical information such as telephone numbers, personal data, banking and payment information, access registration information, and personal identity information.

In an exemplary embodiment, the electronic communication device may be one of the following: a mobile handset, a smart phone, apersonal digital assistant, intelligent mobile device, or a digital watch. In another exemplary embodiment, the electronic communication device includes a subscriber identity module (SIM) which connects electronic communication device to a service provider. In yet another exemplary embodiment, the anonymous device includes an integrated transceiver for communication and may include one of the following: satellite phone, laptop, tablet, digital watch, GPS locator, or a biometric reader. In various exemplary embodiments, identity module is updated in real time with codes/parameters by the authentication server.

In another exemplary embodiment, the authentication server authenticates the electronic communication device only when any one of the identity module and any one of the anonymous device are identified by comparing associated unique identifiers against the ones stored at the authentication database. In yet another exemplary embodiment, the authentication server fails to authenticate electronic communication device if there is no response either from identity module or anonymous device. In yet another exemplary embodiment, one or more anonymous devices may be combined with one or more identity modules to generate unique identifier for more secure authentication. In various exemplary embodiments, identity modules, electronic communication devices and anonymous devices are pre-registered with the authentication server. In yet another exemplary embodiment, the authentication database stores pairing information and ensures that a predetermined identity module or anonymous device is paired with predetermined electronic communication device. In yet another exemplary embodiment, the electronic communication device reaches a temporary dormant state when it fails to receive a response either from identity module or anonymous device.

### BRIEF DESCRIPTION OF THE ACCOMPANYING DRAWINGS

The present invention is described by way of embodiments illustrated in the accompanying drawings wherein:

FIG. 1 is a block diagram of a personal authentication system in an exemplary embodiment;

FIG. 2 is a flowchart illustrating a three factor authentication employed in an exemplary embodiment of the personal authentication system.

### DETAILED DESCRIPTION OF THE INVENTION

A system and method for security of electronic communication devices and services are described herein. The invention provides a personal authentication to one or more user's electronic communication devices via one or more anonymous devices. The present invention also provides a means for disabling or restricting functional aspects of an electronic communication device or service in the event of its theft or loss. The method of the invention may be provided on a computer readable medium.

The following disclosure is provided in order to enable a person having ordinary skill in the art to practice the invention. Exemplary embodiments are provided only for illustrative purposes and various modifications will be readily apparent to persons skilled in the art. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For the purpose of clarity, details relating to technical material that are known in the technical fields related to the invention have not been described in detail so as not to unnecessarily obscure the present invention.

The present invention would now be discussed in context of embodiments as illustrated in the accompanying drawings.

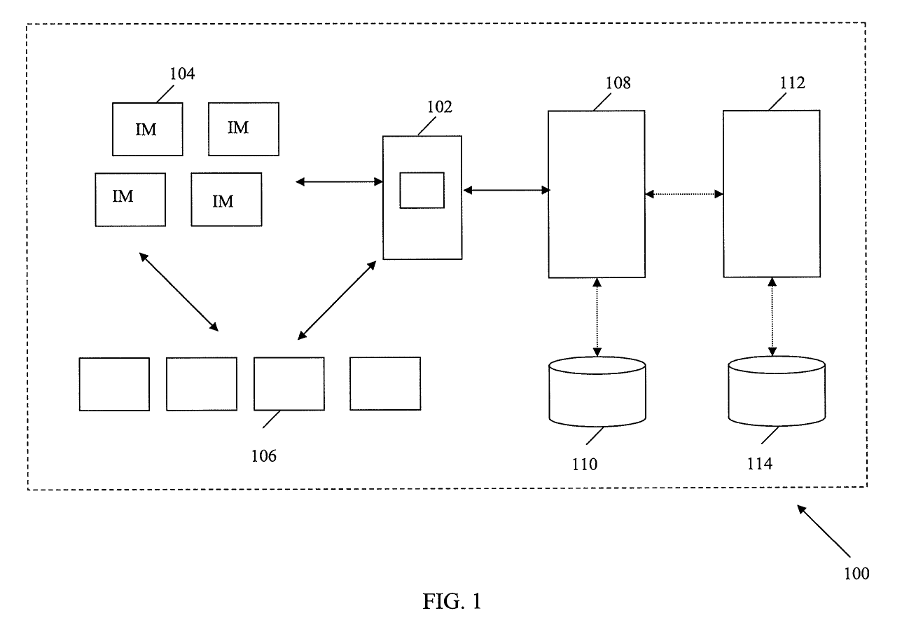

FIG. 1 illustrates a block diagram of a personal authentication system in an exemplary embodiment. Personal authentication system 100 comprises an electronic communication device 102, one or more identity modules 104, one or more anonymous electronic devices 106, an authentication server 108, an authentication database 110, one or more secondary authentication servers 112, and one or more secondary authentication databases 114.

The electronic communication device 102 is a long range, portable electronic device for mobile communication which transmits and receives data and is capable of making and receiving calls. In various exemplary embodiments, electronic communication device 102 is a mobile telephone handset, however, other portable devices such as smart phones, personal digital assistants, intelligent mobile devices etc. may also be used. In an exemplary embodiment, the electronic communication device may be able to transmit and receive data in the form of broadcast or distributed content and visuals, and may also allow peer to peer data and content interchange. In yet another exemplary embodiment, the electronic communication device 102 includes a subscriber identity module (SIM) which connects the electronic communication device 102 to a service provider. In various exemplary embodiments, the electronic communication device 102 is required to register its Mobile Station Integrated Services Digital Network (MSISDN) number with the authentication server 108.

The identity module 104 is an electronic device with a unique identifier. The identity module 104 is provided with an integrated transceiver. The identity module 104 is used with the electronic communication device 102 to enable secure authentication. Each identity module 104 facilitates a virtual path for authentication server 108 to verify each identity module 104 independently via electronic communication device 102.

In an exemplary embodiment, the electronic communication device 102 includes a client application to establish a communication link with identity modules 104 via various protocols. In various exemplary embodiments, Bluetooth protocol is used to maintain a communication link between electronic communication device 102 and one or more identity modules 104, however, other protocols such as IrDA, and Near Field Communication (NFC) may also be used.

The communication carried between electronic communication device 102 and identity module 104 is secure and generally follows secure socket layer (SSL) or similar protocol. SSL is a security protocol that provides communication privacy and enables client/server applications to communicate in a way that is designed to prevent eavesdropping, tampering, and message forgery. The electronic communication device 102 does not store any information on any of the identity modules 104 or personal information related therewith apart from that necessary to establish secure inter device communication between electronic communication device 102 and the one or more identity modules 104. In an exemplary embodiment, communication information stored with the electronic communication device 102 is a Bluetooth security code. In another exemplary embodiment, an encrypted out of band signaling protocol to communicate between the electronic communication device 102 and the identity module 104 may also be employed in the electronic communication device 102.

In an exemplary embodiment, the identity module 104 is updated in real time by the authentication server 108 via electronic communication device 102. The authentication server 108 at regular interval provides updated parameters/codes to ensure that the identity module 104 verified at a later point of time is valid and matches with the one stored at the authentication database 110. The continuous updating of one or more identity modules 104 makes it difficult for an unauthorized person to clone or crack and thus enhances the security of the authentication system. In various exemplary embodiments, a unique serial number i.e. universally unique identifier (UUID) is pre-registered with the authentication server 108 for identifying specific identity module 104 during transaction/authentication.

Anonymous devices 106 are generally electronic devices present in the user surroundings having unique identifiers which are known to an authorized user and to the authentication server 108. Anonymous devices 106 work in combination with one or more identity modules 104 to make authentication safe and personal. In an exemplary embodiment, the authentication of user's electronic communication device 102 is anonymous where the comparison of anonymous device unique identifier is done with the preregistered identifier at the authentication server. In another exemplary embodiment, no personal information is transferred or exchanged. In various exemplary embodiments, electronic devices such as satellite phones, laptops, tablets, digital watches, GPS locator, biometric reader etc. are used, however, other devices such as cameras, biometric readers, may also be employed to work with identity modules 104 to provide additional incremental security and accurate personal authentication of user.

In various exemplary embodiments, a biometric reader may provide a digital code sample of a biometric parameter, such as but not limited to, a fingerprint, a palm print, a voice print, a vein scan, lower dermatologic scan, iris scan, or multiple user's characteristics to be used by the authentication server 108, to reference against a previously recorded parameter provided by the user for use as a biometric UUID. In an exemplary embodiment, multiple user characteristics may further include pulse rate, electrocardiographic signals, spectral characteristics of human tissue, percentage oxygenation of blood, bloodflow, hematocrit, biochemical assays of tissue, electrical plethysmography, transpiration of gases, electrical property of skin, blood pressure, differential blood volumes, etc. The biometric data/parameters provided by the user are recorded, stored, and utilized in a completely anonymous fashion by the authentication server 108. The abovementioned biometric parameters are used in various combinations along with the anonymous devices 106 to provide safe and anonymous authentication.

In another exemplary embodiment, the biometric reader coupled with anonymous device 106 in response to a positive or negative reading may establish a valid/invalid parameter response which may be used to activate or de-activate the electronic communication device 102. The authentication server 108 fails to authenticate the request if any of the abovementioned biometric responses are deemed invalid. The authentication server 108 also fails to authenticate the request if there is no response either from any one identity module 104, or anonymous device 106 coupled with the biometric reader.

In yet another exemplary embodiment, biometric reader may also be used to identify one or more users and enable the authentication sequence and may also provide check against stored digital signatures at the authentication server 102 anonymously.

In various exemplary embodiments, one or more anonymous devices 106 may be combined with one or more identity modules 104 to generate unique identifiers to provide secure authentication. In an exemplary embodiment, anonymous devices 106 are always present in the vicinity of the electronic communication device 102 for continuous verification via integrated transceiver. Various electronic devices present at home, offices, and automobiles can be combined with the identity modules 104 to provide secure authentication.

The authentication server 108 provides authorization services to electronic communication device 102 on the basis of one or more identity modules 104 and one or more anonymous devices 106 present in the vicinity of the electronic communication device 102. In an exemplary embodiment, the authentication server 108 utilizes an existing communication channel to communicate with the electronic communication device 102. Once a communication channel between authentication server 108 and electronic communication device 102 is established, the authentication server 108 requests the electronic communication device 102 to establish another parallel communication with an identity module 104. The communication channel established between the identity module 104 and electronic communication device 102 facilitates a virtual path for authentication server 108 to authenticate identity module 104 via its already established communication with electronic communication device 102.

In various exemplary embodiments, anonymous devices 106 which are linked with identity modules 104 generate another virtual path which extends between electronic communication device 102 and anonymous device 106 having an integrated or external identity module 104. In an exemplary embodiment, the authentication server 108 first identifies electronic communication device 102 and then establishes a virtual communication with one or more identity modules 104 and then with one or more anonymous devices 106 via electronic communication device 102 for anonymous personal authentication. In another exemplary embodiment, various biometric devices along with anonymous devices are also employed to facilitate a virtual path for authentication server 108 via electronic communication device 102.

In an exemplary embodiment, no authentication or user information regarding identity module 104 is stored, in any device including electronic communication device 102. In an exemplary embodiment, the unique identifier information of identity module 104 is stored in the authentication database 110 against which it is authenticated. In various exemplary embodiments, a unique serial number i.e. universally unique identifier (UUID) of each entity is pre-registered with the authentication server 108 for identifying specific entity during a transaction. Various other individual parameters are also stored with the unique identifier to enable interrogation of identity module such as MAC address, generic device UUID, refreshable parameters—set and reset by the authentication server 108 and other unpublished proprietary parameters.

The authentication database 110 stores a range of critical information related to identity modules 104, anonymous devices 106 and electronic communication device 102. The authentication database 110 also stores pairing information and ensures that a specific identity module 104 or anonymous device 106 is paired with the right electronic communication device 102. In addition, information about those electronic communication devices, identity modules and anonymous devices which have been lost or stolen is recorded at the authentication database 110 to ensure trouble free authentication. In various exemplary embodiments, information such as identity module serial numbers, universal unique identifiers (UUID) of each electronic device, mobile parameters such as GSM standards (3GPP) etc. are all stored in the authentication database 110. In an exemplary embodiment, the authentication database 110 is DB2, however, various other databases such as Oracle, SQL Server, MS Access, and FoxPro may also be used to implement the authentication database 110.

In an exemplary embodiment, mobile parameters may further store Mobile Station International Subscriber Identity Number (MSISDN), Mobile Station Identifier (IMSI), and International Mobile Equipment Identity (IMEI). MSISDN is used for uniquely identifying a mobile station in a GSM or UMTS mobile network. IMSI is used to uniquely identify mobile subscriber nationally and internationally, and IMEI is employed to identify handset/hardware to a mobile network via its fifteen digit code.

In various exemplary embodiments, the authentication server 108 and authentication database 110 are supplemented by secondary authentication servers 112 and secondary databases 114. The secondary database 114 stores user details and is used for highly secure corporate, military, finance and third party applications. In various exemplary embodiments, critical information such as telephone numbers, personal data, banking and payment information, access registration information, personal identity information and closed user group data is stored in the secondary databases 114. The secondary authentication database 114 is separated from the anonymous data via secondary authentication server 112 and secure common interface. In an exemplary embodiment, an anonymous Id is employed while requesting authentication from authentication server 108 and authentication database 110. The authentication server 108 and authentication database 110 only recognizes request associated with the anonymous Id, thereby assuring that the data and requests for authentication are always interchanged in an anonymous fashion.

In various exemplary embodiments, the electronic communication device 102 when leaves the secure environment comprising of one or more identity modules 104 and anonymous electronic devices 106, it reaches a temporary dormant state automatically. The electronic communication device 102 is placed in the temporary dormant state when it fails to receive a reply signal either from identity modules 104 or anonymous devices 106. While in the temporary dormant state the electronic communication device 102 continues to send interrogation signal, however only on entering secure environment comprising of identity modules 104 and anonymous devices 106, electronic communication device 102 is activated. The temporary dormant state helps in preventing third parties from accessing specific device or user information from the electronic communication device 102 in the event the device has been obtained from an authorized user without their consent.

In operation, each identity module 104 is unique therefore the relationship between electronic communication device 102, one or more identity modules 104, and authentication server 108 is also unique when considered together. In various exemplary embodiments, a basic three factor authentication is employed to make personal authentication system secure.

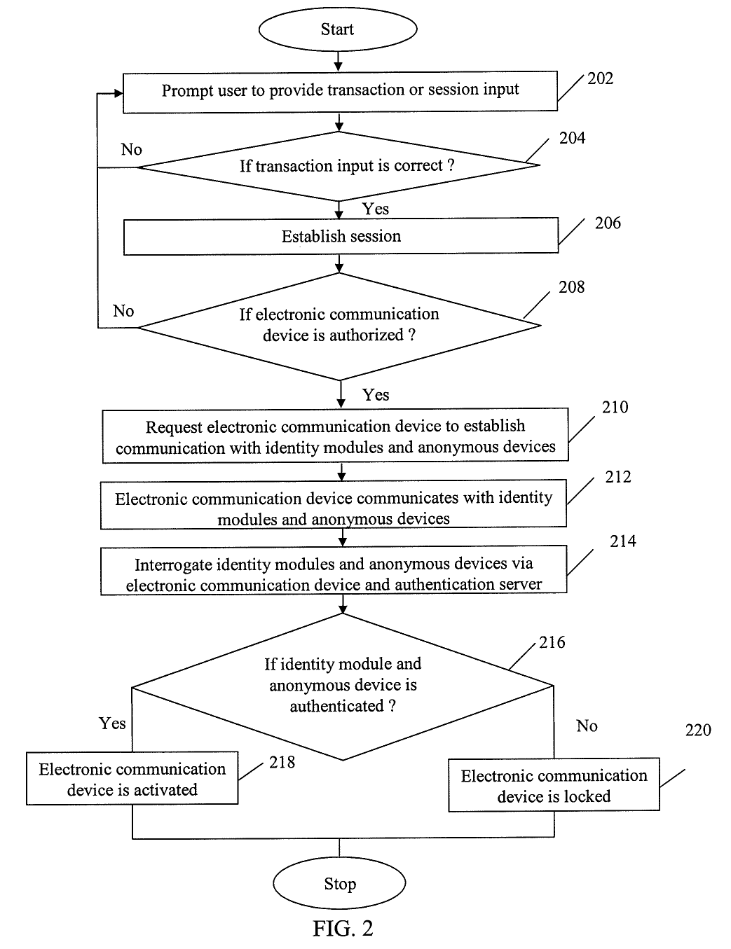

FIG. 2 is a flowchart illustrating a three factor authentication employed in the exemplary embodiment of the personal authentication system. At step 202, a user is prompted to provide a transaction or a session input. In an exemplary embodiment, the transaction or session input may be provided to any computing device, biometric reader, card reader or an anonymous NFC card reader. The computing device or card reader may capture the desired transaction input from the user, manually or automatically. In another exemplary embodiment, the transaction or session input may comprise a credit card number, password, personal identification number (PIN), a string of characters, etc. or an anonymous biometric signal.

At step 204, a check is performed to ensure whether the transaction input provided by the user is valid. If it is ascertained that the transaction input provided by the user is not valid then step 202 is repeated. If it is ascertained that the transaction input provided by the user is valid then at step 206, a session is established to carry out further authentications/transactions.

At step 208, a check is performed to ensure whether the electronic communication device has been authorized. In an exemplary embodiment, the authorization is achieved by comparing the unique universal id (UUID) of the electronic communication device with the one stored at the authentication database. In another exemplary embodiment, a biometric reader, card reader, near field card reader etc. may help in identifying the authentication parameters stored at the authenticating server or a combination of authentication parameters and UUIDs. If it is ascertained that the electronic communication device has not been authorized then step 202 is repeated.

If it is ascertained that the electronic communication device has been authorized, then at step 210, authentication server requests electronic communication device to establish communication with one or more identity modules and one or more anonymous devices.

At step 212, the electronic communication device communicates with one or more identity modules and one or more anonymous devices. In an exemplary embodiment, the electronic communication device does not store any personal information related to owner identification. In another exemplary embodiment, communication between the electronic communication device, identity module, and anonymous device is carried out without user intervention. In yet another exemplary embodiment, communication between the electronic communication device and anonymous device is carried out via integrated or external identity modules automatically.

At step 214, the authentication server interrogates one or more identity modules and one or more anonymous devices via electronic communication device which has already established the connection. At step 216, a check is performed whether the authentication server has verified one or more identity module and one or more anonymous devices. If it is ascertained that the authentication server has verified one or more identity module and one or more anonymous devices, then at step 218 the electronic communication device can transfer data/voice without any interruption. If it is ascertained that the authentication server has not verified one or more identity modules and one or more anonymous devices, then at step 220 the electronic communication service is rendered inoperative.

In various exemplary embodiments, for more security of electronic communication device one or more identity modules are used in combination with one or more anonymous devices to form unique identifiers to enable effective authentication. For example, one or more anonymous devices such as cameras, watches, computing devices, GPS locators etc. having integrated or external identity module may combine with identity modules to form unique identifiers which are then compared with the predetermined unique identifiers stored at the authentication server.

The present invention may be implemented in numerous ways including as a system, a method, or a computer readable medium such as a computer readable storage medium or a computer network wherein programming instructions are communicated from a remote location.

The system, method and computer program product for providing security as described herein is particularly well suited for portable mobile devices and services, however, may be applied to various personal authentication in other domains such as financial authentications, home security, business security, military security, securing adult content, gaming, integrated identity management, home identity management, building access, dynamic session control in real time, academia, student identity management, library management etc. by performing minor modifications as would be apparent to a person of skill in the art.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention.

We claim:

1. A personal authentication system comprising:
an electronic communication device for transmitting and receiving data;
at least one identity module comprising an integrated transceiver with unique identifier in the vicinity of electronic communication device;
at least one anonymous device having unique identifier in the vicinity of electronic communication device; and
an authentication server providing authorization services to electronic communication device by comparing unique identifiers of electronic communication device, identity modules, and anonymous devices with the ones stored at authentication database.

2. The system as claimed in claim 1, further comprising a secondary authentication server for providing critical information and supplementing first authentication server.

3. The system as claimed in claim 1, further comprising a secondary authentication database for storing critical information such as telephone numbers, personal data, banking and payment information, access registration information, and personal identity information.

4. The system as claimed in claim 1, wherein the electronic communication device may be one of the following: a mobile handset, a smart phone, a personal digital assistant, intelligent mobile device, or a digital watch.

5. The system as claimed in claim 1, wherein the electronic communication device includes a subscriber identity module (SIM) which connects electronic communication device to a service provider.

6. The system as claimed in claim 1, wherein the anonymous device includes an integrated transceiver for communication.

7. The system as claimed in claim 1, wherein the identity module is updated in real time with codes/parameters by the authentication server.

8. The system as claimed in claim 1, wherein the anonymous device includes at least one of the following: satellite phone, laptop, tablet, digital watch, GPS locator, or a biometric reader.

9. The system as claimed in claim 1, wherein the authentication server authenticates the electronic communication device only when any one of the identity module and any one of the anonymous device are identified comparing associated unique identifiers against the ones stored at the authentication database.

10. The system as claimed in claim 1, wherein the authentication server fails to authenticate electronic communication device if there is no response either from identity module or anonymous device.

11. The system as claimed in claim 1, wherein one or more anonymous devices may be combined with one or more identity modules to generate unique identifier for more secure authentication.

12. The system as claimed in claim 1, wherein the authentication server authorizes one or more identity modules via electronic communication device.

13. The system as claimed in claim 1, wherein the authentication server authorizes one or more anonymous devices via electronic communication device.

14. The system as claimed in claim 1, wherein each identity module, electronic communication device and anonymous device is pre-registered with the authentication server.

15. The system as claimed in claim 1, wherein the authentication database stores pairing information and ensures that a predetermined identity module or anonymous device is paired with predetermined electronic communication device.

16. The system as claimed in claim 1, wherein the electronic communication device reaches a temporary dormant state when it fails to receive a response either from identity module or anonymous device.

17. A method for providing personal authentication, the method comprising the steps of:
initiating a session or transaction by providing an input to an electronic communication device;
requesting the electronic communication device to establish communication with one or more identity modules and one or more anonymous devices in the vicinity, if the electronic communication device is authorized;
interrogating one or more identity modules and one or more anonymous device via electronic communication device and authentication server, after the communication is established between the electronic communication device, one or more identity modules and one or more anonymous devices; and
activating the electronic communication device if the one or more identity modules and one or more anonymous devices are authenticated by the authentication server.

18. The method as claimed in claim 17, further comprising the step of locking the electronic communication device if the identity module or anonymous device is not authenticated by the authentication server.

19. The method as claimed in claim 17, further comprising the step of deactivating the electronic communication device and placing it in a temporary dormant state when it fails to receive a response either from identity module or anonymous device.

20. The method as claimed in claim 17, wherein the input may comprise a credit card number, password, PIN, a string of characters, or an anonymous biometric signal.

21. The method as claimed in claim 17, wherein authentication of electronic communication device comprises comparing associated unique identifiers thereof against ones stored in an authentication database.

22. The method as claimed in claim 17, wherein authentication of identity modules comprises comparing associated unique identifiers thereof against ones stored in an authentication database.

23. The method as claimed in claim 17, wherein authentication of anonymous devices comprises comparing associated unique identifiers thereof against ones stored in an authentication database.

24. A method for providing personal authentication, the method comprising the steps of:
(i) prompting a user of an electronic communication device to provide transaction or session input;
(ii) establishing a session if the transaction or session input is valid;
(iii) repeating step (i) if the transaction or session input is not valid;
(iv) determining if the electronic communication device is authorized by authentication server, if the transaction or session input is valid and a session is established;
(v) repeating step (i-iv) if the electronic communication device is not authorized;
(vi) requesting electronic communication device to establish communication with one or more identity modules and one or more anonymous devices in the vicinity, if the electronic communication device is authorized;
(vii) interrogating one or more identity modules and one or more anonymous device via electronic communication device and authentication server, after the communication is established between the electronic communication device, one or more identity modules and one or more anonymous devices; and
(viii) activating the electronic communication device if the one or more identity modules and one or more anonymous devices are authenticated by the authentication server.
